(19) United States
(12) Patent Application Publication
(10) Pub. No.: US 2007/0220283 A1
(43) Pub. Date: Sep. 20, 2007

(54) Power-switching system for automatically adjusting voltage and method for automatically adjusting voltage via the power-switching system

(76) Inventors: Li-Lin Jen, Hsi-Chih (TW); Hsing-Chun Wu, Hsi-Chih (TW); Ming-Cheng Lin, Hsi-Chih (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/378,433

(22) Filed: Mar. 20, 2006

(51) Int. Cl. G06F 1/00

(52) U.S. Cl. 713/300

(57) ABSTRACT

A power-switching system for automatically adjusting voltage includes a power-switching module and a power-storing module. The power-switching module has one side electrically connected with a power source, and the power-switching module has a built-in memory unit. The power-storing module is electrically connected with the other side of the power-switching module, and the power-storing module has a firmware unit to provide a predetermined voltage message that the power-storing module needs. Whereby, when the memory unit reads the predetermined voltage message, an output voltage of the power-switching module is automatically adjusted. Moreover, when the power-switching module is used in a predetermined extraordinary status, the extraordinary status is transformed into an extraordinary digital code, and the extraordinary digital code is stored in the memory unit. Hence, designers or users will know what will occur when using the power-switching module when the extraordinary status occurs according to the extraordinary digital code.

### BACKGROUND OF THE INVENTION

1. Field of the Invention

The present invention relates to a power-switching system for automatically adjusting voltage and a method for automatically adjusting voltage via the power-switching system, and particularly relates to when a memory unit reads a predetermined voltage message whereby an output voltage for the power-switching module is automatically adjusted. Moreover, when the power-switching module is used in a predetermined extraordinary status, the extraordinary status is transformed into an extraordinary digital code, and the extraordinary digital code is stored in the memory unit.

2. Description of the Related Art

It is very important for portable electronic devices such as notebooks, PDAs or mobile phones to have batteries that perform well, and it is a difficult problem that designers want to solve. In general, users need to buy many different power adapters for providing different output voltages according to the different demands of different electronic devices. Although the user can buy a power adapter that can adjust output voltage manually, it is inconvenient for user.

### SUMMARY OF THE INVENTION

The present invention provides a power-switching system for automatically adjusting voltage and a method for automatically adjusting voltage via the power-switching system. When the memory unit reads a predetermined voltage message, an output voltage of the power-switching module is automatically adjusted. Moreover, when the power-switching module is used in a predetermined extraordinary status, the extraordinary status is transformed into an extraordinary digital code, and the extraordinary digital code is stored in the memory unit. In other words, the power-switching module can automatically adjust its output voltage by reading the predetermined voltage message without replacing the power-switching module or using another power-switching module.

A first aspect of the present invention is a power-switching system for automatically adjusting voltage, comprising a power-switching module and a power-storing module. The power-switching module has one side electrically connected with a power source, and the power-switching module has a built-in memory unit. The power-storing module is electrically connected with the other side of the power-switching module, and the power-storing module has a firmware unit to provide a predetermined voltage message that the power-storing module needs. Whereby, when the memory unit reads the predetermined voltage message, an output voltage of the power-switching module is automatically adjusted.

A second aspect of the present invention is a method for automatically adjusting voltage via a power-switching system, comprising: providing a predetermined voltage message that a power-storing module needs via a firmware unit of a power-storing module; reading the predetermined voltage message via a built-in memory unit of a power-switching module that connects with one side of the power-storing module; and automatically adjusting an output voltage of the power-switching module via the predetermined voltage message that the memory unit has read.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block diagram of a power-switching system for automatically adjusting voltage according to the present invention; and

FIG. 2 is a flowchart of a method for automatically adjusting voltage via a power-switching system according to the present invention.

### DETAILED DESCRIPTION OF PREFERRED BEST MOLDS

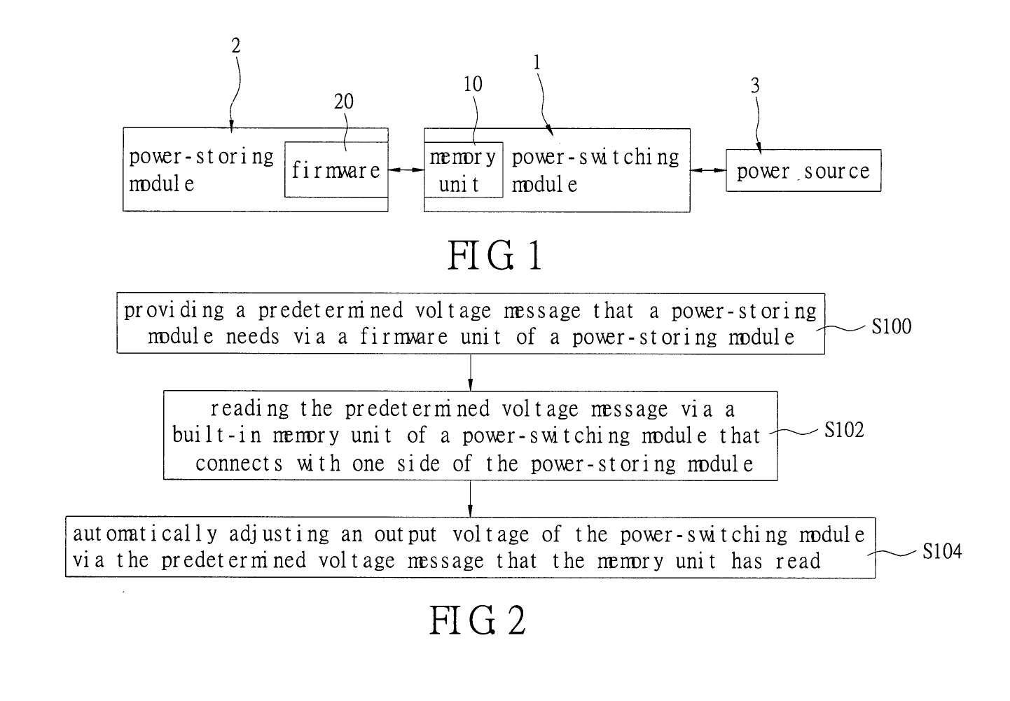

Referring to FIG. 1, the present invention provides a power-switching system for automatically adjusting voltage. The power-switching system comprises a power-switching module 1 and a power-storing module 2.

The power-switching module 1 has one side electrically connected with a power source 3, and the power-switching module 1 has a built-in memory unit 10. The memory unit 10 can be a rewritable memory. Moreover, the power-storing module 2 is electrically connected with the other side of the power-switching module 1, and the power-storing module 2 has a firmware unit 20 to provide a predetermined voltage message that the power-storing module 2 needs. The power-storing module 2 can be a portable battery.

Furthermore, the predetermined voltage message can be transformed into a voltage digital code. The power-switching module 1 is automatically adjusted according to the voltage digital code. In addition, the voltage digital code has eight settings that correspond to 12V, 15V, 16V, 17V, 18V, 19V, 20V and 24V output voltage of the power-switching module 1. For example, when the output voltage that the power-storing module 2 needs is 12V, the firmware unit 20 provides a 12V voltage message and the 12V voltage message is transformed into a 12 voltage digital code. Hence, when the memory unit 10 reads the 12 voltage digital code that is provided from the firmware unit 20, the output voltage of the power-switching module 1 is automatically adjusted to 12V. In other words, when the memory unit 10 reads the voltage digital code or the predetermined voltage message, the output voltage of the power-switching module 1 is automatically adjusted.

Moreover, when the power-switching module 1 is used in a predetermined extraordinary status such as an overload, an overcurrent or a short circuit, the extraordinary status is transformed into an extraordinary digital code, and the extraordinary digital code is stored in the memory unit 10. Hence, designers or users will know what will occur when using the power-switching module 1 when the extraordinary status occurs according to the extraordinary digital code.

Referring to FIG. 2, the present invention provides a method for automatically adjusting voltage via a power-switching system according to the present invention. The steps of the method comprises: firstly, providing a predetermined voltage message that a power-storing module 2 needs via a firmware unit 20 of a power-storing module 2 (S100); reading the predetermined voltage message via a built-in memory unit 10 of a power-switching module 1 that connects with one side of the power-storing module 2 (S102); and automatically adjusting an output voltage of the power-switching module 1 via the predetermined voltage message that the memory unit 10 has read (S104).

Furthermore, the method further comprises: recording extraordinary statuses that occur while using the power-switching module 1 via the memory unit 10, wherein the extraordinary statuses are transformed into corresponding extraordinary digital codes via the power-switching module 1 and the corresponding extraordinary digital codes are stored in the memory unit 10. Hence, designers or users will know what will occur when using the power-switching module 1 when the extraordinary status occurs according to the extraordinary digital code.

In conclusion, the power-switching module 1 can automatically adjust its output voltage by reading the predetermined voltage message without replacing the power-switching module 1 or using another power-switching module. Moreover, when the power-switching module 1 is used in a predetermined extraordinary status such as an overload, an overcurrent or a short circuit, the extraordinary status is transformed into an extraordinary digital code, and the extraordinary digital code is stored in the memory unit 10. Hence, designers or users will know what will occur when using the power-switching module 1 when the extraordinary status occurs according to the extraordinary digital code.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power-switching system for automatically adjusting voltage, comprising:
a power-switching module having one side electrically connected with a power source, and the power-switching module having a built-in memory unit; and
a power-storing module electrically connected with the other side of the power-switching module, and the power-storing module having a firmware unit to provide a predetermined voltage message that the power-storing module needs;
whereby, when the memory unit reads the predetermined voltage message, an output voltage of the power-switching module is automatically adjusted.

2. The power-switching system as claimed in claim 1, wherein the memory unit is a rewritable memory.

3. The power-switching system as claimed in claim 1, wherein the predetermined voltage message is transformed into a voltage digital code, and the power-switching module is automatically adjusted according to the voltage digital code.

4. The power-switching system as claimed in claim 3, wherein the voltage digital code has eight settings that correspond to 12V, 15V, 16V, 17V, 18V, 19V, 20V and 24V output voltage of the power-switching module.

5. The power-switching system as claimed in claim 1, wherein the power-storing module is a portable battery.

6. The power-switching system as claimed in claim 1, wherein when the power-switching module is used in a predetermined extraordinary status, the extraordinary status is transformed into an extraordinary digital code, and the extraordinary digital code is stored in the memory unit.

7. A method for automatically adjusting voltage via a power-switching system, comprising:
providing a predetermined voltage message that a power-storing module needs via a firmware unit of a power-storing module;
reading the predetermined voltage message via a built-in memory unit of a power-switching module that connects with one side of the power-storing module; and
automatically adjusting an output voltage of the power-switching module via the predetermined voltage message that the memory unit has read.

8. The method as claimed in claim 7, wherein the memory unit is a rewritable memory.

9. The method as claimed in claim 7, wherein the predetermined voltage message is transformed into a voltage digital code, and the power-switching module is automatically adjusted according to the voltage digital code.

10. The method as claimed in claim 9, wherein the voltage digital code has eight settings that correspond to 12V, 15V, 16V, 17V, 18V, 19V, 20V and 24V output voltage of the power-switching module.

11. The method as claimed in claim 7, wherein the power-storing module is a portable battery.

12. The method as claimed in claim 7, further comprising: recording extraordinary statuses that occur while using the power-switching module via the memory unit, wherein the extraordinary statuses are transformed into corresponding extraordinary digital codes via the power-switching module and the corresponding extraordinary digital codes are stored in the memory unit.
